(19) United States
(12) Patent Application Publication
(10) Pub. No.: US 2014/0158507 A1
(43) Pub. Date: Jun. 12, 2014

(54) TOUCH PANEL

(71) Applicant: SUMSUNG ELECTRO-MECHANICS CO., LTD., Suwon (KR)

(72) Inventors: Sung Yeol Park, Suwon (KR); Suk Jin Ham, Suwon (KR); Jung Tae Park, Suwon (KR); Seung Heon Han, Suwon (KR); Jung Eun Noh, Suwon (KR)

(73) Assignee: Sumsung Electro-Mechanics Co., Ltd., Suwon (KR)

(21) Appl. No.: 13/780,152

(22) Filed: Feb. 28, 2013

(30) Foreign Application Priority Data
Dec. 12, 2012 (KR) 10-2012-0144429

(51) Int. Cl. H01H 1/06

(52) U.S. Cl. CPC H01H 1/06
USPC 200/279

(57) ABSTRACT

The touch panel according to a preferred embodiment of the present invention includes: a transparent substrate having one surface on which a first groove portion is formed and the other surface on which a second groove portion is formed; a first electrode formed on one surface of the transparent substrate so as to cross the first groove portion; and a second electrode formed on the other surface of the transparent substrate so as to cross the second groove portion.

### CROSS REFERENCE TO RELATED APPLICATION

This application claims the benefit of Korean Patent Application No. 10-2012-0144429, filed on Dec. 12, 2012, entitled “Touch Panel” which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

Meanwhile, the touch panel is classified into a resistive type, a capacitive type, an electromagnetic type, a surface acoustic wave (SAW) type, and an infrared type. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

At present, in the capacitive type touch panel, as described in Korean Patent Laid-Open Publication No. 2012-0044268, a touch panel using an indium-tin oxide (ITO) or conductive polymer metal mesh pattern as a transparent electrode has been used.

At present, in the capacitive type touch sensor, as described in Korean Patent Laid-Open Publication No. 2012-0044268, a touch panel using an indium-tin oxide (ITO) or conductive polymer and metal as a transparent electrode has been used. However, there is a problem in that a touch panel using opaque metal degrades visibility due to a visualized electrode pattern.

### PRIOR ART DOCUMENT

### Patent Document

(Patent Document 1) Korean Patent Laid-Open Publication No. 2012-0044268

### SUMMARY OF THE INVENTION

The present invention has been made in an effort to provide a touch panel including an electrode with improved visibility.

According to a preferred embodiment of the present invention, there is provided a touch panel, including: a transparent substrate having one surface on which a first groove portion is formed and the other surface on which a second groove is formed; a first electrode formed on one surface of the transparent substrate so as to cross the first groove portion; and a second electrode formed on the other surface of the transparent substrate so as to cross the second groove portion.

The first groove portion may be formed in a plurality of rows and the second groove portion may be formed in a plurality of columns.

The first electrode may be formed in a plurality of columns and the second electrode may be formed in a plurality of rows.

The first electrode and the second electrode may be each formed along both surfaces of the transparent substrate and formed along bottom surfaces and sides of the first groove portion and the second groove portion.

The first electrode and the second electrode may be formed at a thickness 30% smaller than depths and widths of the first groove portion and the second groove portion.

Transverse sections of the first groove and the second groove may be formed in a quadrangular shape.

According to another preferred embodiment of the present invention, there is provided a touch panel, including: a first transparent substrate having one surface on which a first groove portion is formed; a first electrode formed on one surface of the first transparent substrate so as to cross a first groove portion; a second transparent substrate having one surface on which a second groove portion is formed; a second electrode formed on one surface of the second transparent substrate so as to cross the groove; and an adhesive layer formed between the first transparent substrate and the second transparent substrate.

The first groove portion may be formed in a plurality of rows and the second groove portion may be formed in a plurality of columns.

The first electrode may be formed in a plurality of columns and the second electrode may be formed in a plurality of rows.

The first electrode and the second electrode may be each formed along both surfaces of the first transparent substrate and the second transparent substrate and formed along bottom surfaces and sides of the first groove portion and the second groove portion.

The first electrode and the second electrode may be formed at a thickness 30% smaller than depths and widths of the first groove portion and the second groove portion.

Transverse sections of the first groove portion and the second groove portion may be a quadrangular shape.

According to a still another preferred embodiment of the present invention, there is provided A touch panel, including: a transparent substrate having one surface on which a groove portion is formed; and a first electrode and a second electrode formed on one surface of the transparent substrate to cross the groove portion.

The groove portion may be formed in a plurality of rows or columns.

The first electrode and the second electrode may be formed in a plurality of rows or columns.

The first and second electrodes may be alternately formed.

The first electrode and the second electrode may be formed on one surface of the transparent substrate and formed along a bottom surface and a side of the groove portion.

The transverse section of the groove portion may be formed in a quadrangular shape.

The first electrode and the second electrode may be formed in a thickness 30% smaller than a depth and a width of the groove portion.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a touch panel according to a first preferred embodiment of the present invention;

FIG. 2 is a cross-sectional view of the touch panel according to the first preferred embodiment of the present invention;

FIG. 3 is a perspective view illustrating a bottom part of a transparent substrate in the touch panel according to the first preferred embodiment of the present invention;

FIG. 4 is a perspective view illustrating an example of an electrode in the touch panel according to the first preferred embodiment of the present invention;

FIG. 5 is an exploded perspective view of a touch panel according to a second preferred embodiment of the present invention;

FIG. 6 is a cross-sectional view of the touch panel according to the second preferred embodiment of the present invention;

FIG. 7 is an exploded perspective view of a touch panel according to a third preferred embodiment of the present invention;

FIG. 8 is a cross-sectional view of the touch panel according to the third preferred embodiment of the present invention; and

FIG. 9 is a plan view illustrating another example of an electrode pattern in the touch panel according to the third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention are described in detail with reference to the accompanying drawings.

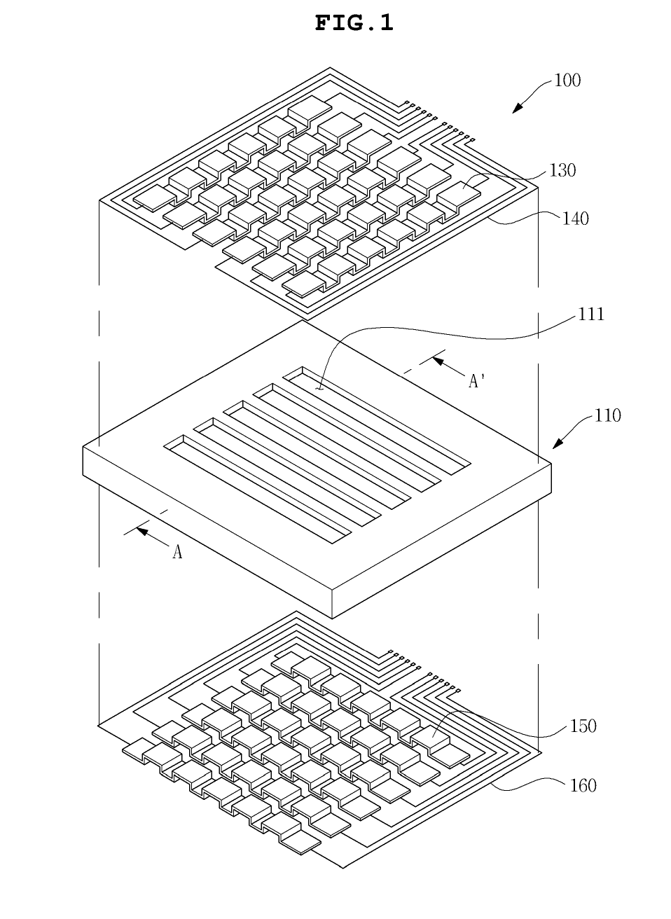

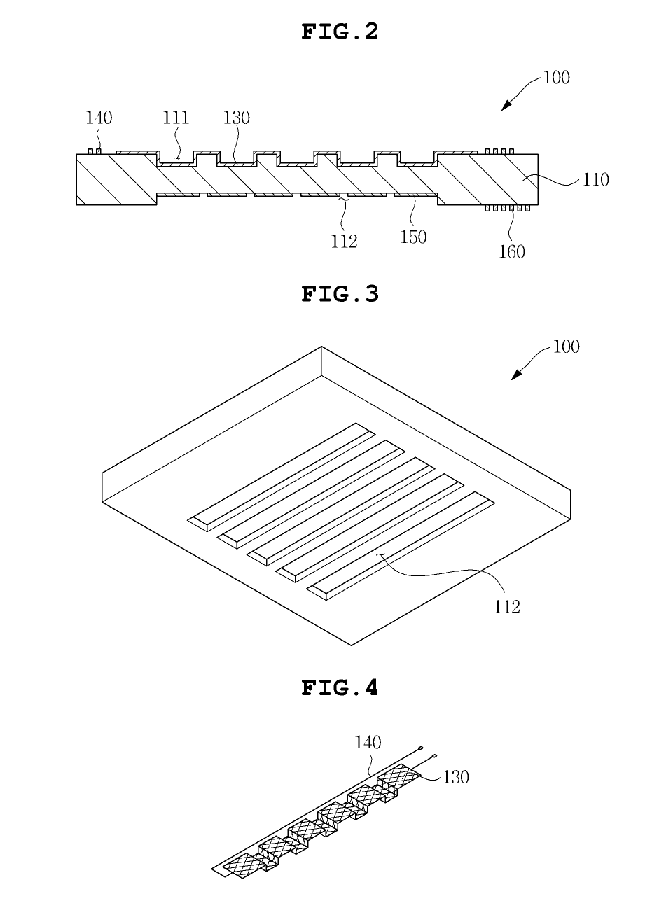

FIG. 1 is an exploded perspective view of a touch panel according to a first preferred embodiment of the present invention and FIG. 2 is a cross-sectional view of the touch panel according to the first preferred embodiment of the present invention.

As illustrated in FIGS. 1 and 2, a touch panel 100 according to a preferred embodiment of the present invention is configured to include a transparent substrate 110 and an electrode configured of a first electrode 130 and a second electrode 150 that are formed on both surfaces of the transparent substrate 110.

FIG. 3 is a perspective view illustrating a bottom part of a transparent substrate in the touch panel according to the first preferred embodiment of the present invention.

Referring first to FIGS. 1 and 3, the transparent substrate 110 has a first groove portion 111 formed on one surface thereof and a second groove portion 112 formed on the other surface thereof. In this configuration, the first groove portion 111 may be formed on one surface of the transparent substrate 110 in a plurality of rows and the second groove portion 112 may be formed in a plurality of columns. However, the present invention is not necessarily limited herein. For example, the first groove portion 111 may be formed on one surface of the transparent 110 in a plurality of columns and the second groove portion 112 may be formed in a plurality of rows.

Further, the transparent substrate 110 serves to provide an area in which the first and second electrodes 130 and 150 are formed. Herein, the transparent substrate 110 needs to have a support force capable of supporting the first and second electrodes 130,150 and transparency to allow a user to recognize images provided from an image display device (not illustrated). In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but the present invention is not necessarily limited thereto.

Meanwhile, a high frequency treatment or a primer treatment may be performed so as to activate both surfaces of the transparent substrate 110. The adhesion between the transparent 110 and the first and second electrodes 130 and 150 can be improved by activating both surfaces of the transparent substrate 110.

Referring to FIG. 2, the first and second electrodes 130 and 150 generate signals when being touched by a user so as to allow a controller to recognize touched coordinates. Further, the first electrode 130 is formed on one surface of the transparent substrate 110 and the second electrode 150 is formed on the other surface of the transparent substrate 110, such that the first and second electrodes 130 and 150 may face each other based on the transparent substrate 110. In this case, the first electrode 130 may be formed of a driving electrode and the second electrode 150 may be formed of a sensing electrode, but the present invention is not limited to thereto. For example, the first electrode 130 may be formed of a sensing electrode and the second electrode 150 may be formed of a driving electrode.

Further, referring to FIGS. 1 to 3, the first electrode 130 and the second electrode 150 are formed on both surfaces of the transparent substrate 110 but formed to cross each of the first groove portion 111 and the second groove portion 112 that are formed on both surfaces of the transparent substrate 110. In this case, the first electrode 130 and the second electrode 150 are formed along bottom surfaces and sides of the first groove portion 111 and the second groove portion 112, but may be formed in an orthogonal direction to the first groove portion 111 and the second groove portion 112.

Herein, for example, the first electrode 130 may be formed on one surface of the transparent substrate 110 in a plurality of columns and the first groove portion 111 may be formed in a plurality of rows. Further, the second electrode 150 may be formed on the other surface of the transparent substrate 110 in a plurality of rows and the second groove portion 112 may be formed in a plurality of columns. In this case, the first electrode 130 and the first groove portion 111 are formed in an orthogonal direction to each other and the second electrode 150 and the second groove portion 112 may be formed in an orthogonal direction to each other.

However, the first preferred embodiment of the present invention is not limited to the case in which the first electrode 130 is formed on one surface of the transparent substrate 110 in a column and the second electrode 150 is formed on the other surface of the transparent substrate 110 in a row. For example, the first electrode 130 may be formed on one surface of the transparent substrate 110 in a row and the second electrode 150 may be formed on the other surface of the transparent substrate 110 in a column.

Meanwhile, the first electrode 130 and the second electrode 150 may be formed at a thickness 30% smaller than depths and widths of the first groove portion 111 and the second groove portion 112. In this case, the first electrode 130 and the second electrode 150 may be formed in, for example, a thin film form.

Further, transverse sections of the first groove portion 111 and the second groove portion 112 may be in a rectangular shape, but the present invention is not limited thereto.

FIG. 4 is a perspective view illustrating an example of an electrode in the touch panel according to the first preferred embodiment of the present invention.

In addition, the first and second electrode patterns 130 and 150 may be formed of copper (Cu), aluminum (Al), gold (Au), silver (Ag), titanium (Ti), palladium (Pd), and chromium (Cr), or a combination thereof. Herein, as illustrated in FIG. 4, the first and second electrodes 130 and 150 may be formed in, for example, a mesh pattern. In this case, the first and second electrodes 130 and 150 may be formed by a plating process or a deposition process.

Meanwhile, when the first and second electrodes 130 and 150 are formed of copper (Cu), the surfaces of the first and second electrode 130 and 150 may be preferably black-oxidized. Here, the black-oxidation elutes Cu₂O or CuO by oxidizing the surfaces of the first and second electrodes 130 and 150. Meanwhile, the Cu₂O has brown, and therefore is referred to as brown oxide and the CuO has black, and therefore is referred to as black oxide. As such, the reflection of light may be prevented by black-oxidizing the surfaces of the first and second electrodes 130 and 150, such that the visibility of the touch panel 100 may be improved.

Further, the first and second electrodes 130 and 150 may be formed to have a line width of 7 μm or less and a pitch of 900 μm or less, such that the visibility of the touch panel 100 may be to improved. However, the line width and the pitch of the first and second electrodes 130 and 150 according to the first preferred embodiment of the present invention are not limited thereto.

Meanwhile, in addition to the foregoing metals, the first and second electrodes 130 and 150 may also be formed of metal silver formed by exposing/developing a silver salt emulsion layer.

Further, the first and second electrodes 130 and 150 may be formed to have a surface shape by using conductive polymer or metal oxide.

Here, the conductive polymer has excellent flexibility and a simple coating process. In this case, the conductive polymer may be formed of poly-3,4-ethylenedioxythiophene/polystyrenesulfonate (PEDOT/PSS), polyaniline, polyacetylene, or polyphenylenevinylene.

In addition, the metal oxide may be formed of indium-tin oxide.

Further, when the first and second electrodes 130 and 150 are formed of conductive polymer or metal oxide, the first and second electrodes 130 and 150 may be formed by a dry process, a wet process, or a direct patterning process. Here, the dry process means sputtering, evaporation, and the like, the wet process means dip coating, spin coating, roll coating, spray coating, and the like, and the direct patterning process means screen printing, gravure printing, inkjet printing, and the like.

Here, when the first and second electrodes 130 and 150 are formed of conductive polymer or metal oxide, the first and second electrodes 130 and 150 may be formed in a bar type pattern in the drawings, but the present invention is not limited thereto. Therefore, the first and second electrodes 130 and 150 may be formed in all the patterns known in the art such a diamond pattern, a quadrangular pattern, a triangular pattern, a circular pattern, and the like.

Meanwhile, the image display device that serves to output images in the other surface direction of the transparent substrate 110 may be provided.

In addition, an edge of the first electrode 130 is provided with a first electrode wiring 140 that is supplied with an electrical signal from the first electrode 130 and an edge of the second electrode 150 is formed with the second electrode wiring 160 that is supplied with an electrical signal from the second electrode 150. In this case, the first electrode wiring 140 is integrally formed with the first electrode pattern 130 and the second electrode wiring 160 is integrally formed with the second electrode 150, thereby simplify the manufacturing process and shorten lead time.

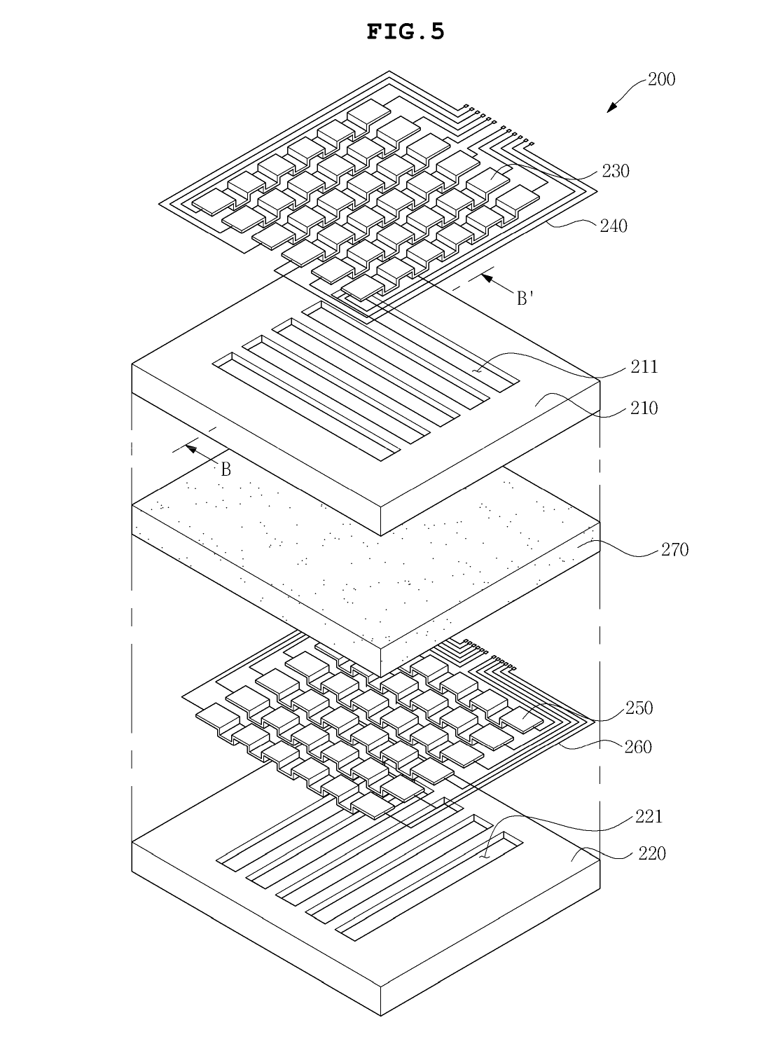

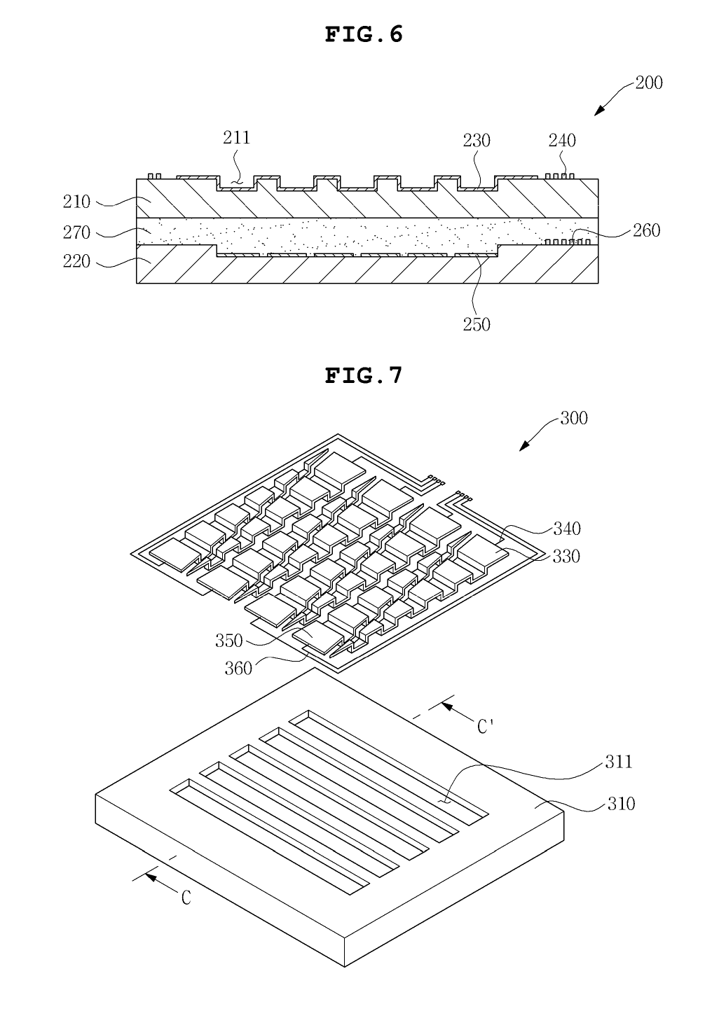

FIG. 5 is an exploded perspective view of a touch panel according to a second preferred embodiment of the present invention and FIG. 6 is a cross-sectional view of the touch panel according to the second preferred embodiment of the present invention.

As illustrated in FIGS. 5 and 6, a touch panel 200 according to the second embodiment of the present invention is configured to include a first transparent substrate 210, a first electrode 230 formed on one surface of the first transparent substrate 210, a second transparent substrate 220, a second electrode 250 formed on one surface of the second transparent substrate 220, and an adhesive layer 270 that adheres between the first transparent substrate 210 and the second transparent substrate 220.

When comparing with the touch panel 100 according to the first preferred embodiment of the present invention, the touch panel 200 according to the second preferred embodiment of the present invention has a difference in that the first electrode 230 is formed on the first transparent substrate 210 and the second electrode 250 is formed on the second transparent substrate 220. Therefore, the contents in which the second preferred embodiment of the present invention overlaps the first preferred embodiment of the present invention will be briefly described and only the difference will be mainly described.

First, one surface of the first transparent substrate 210 is provided with a first groove portion 221 and one surface of the second transparent substrate 220 is provided with a second groove portion 222. For example, the first groove portion 221 is formed on one surface of the first transparent substrate 210 in a plurality of rows and the second groove portion 222 is formed on one surface of the second transparent substrate 220 in a plurality of columns.

Further, the first and second transparent substrates 210 and 220 serve to provide an area in which the first and second electrodes 130 and 150 are formed. In this case, a high frequency treatment or a primer treatment may be preferably performed so as to activate the surfaces of the first and second transparent substrates 210 and 220. As such, the adhesion between the first and second transparent substrates 210 and 220 and between the first and second electrodes 230 and 250 may be improved by activating the surfaces of the first and second transparent substrates 210 and 220.

The first and second electrodes 230 and 250 generate signals when being touched by a user so as to allow a controller to recognize touched coordinates. Here, the first electrode 230 may be formed on one surface of the first transparent substrate 210 and the second electrode 250 may be formed on one surface of the second transparent substrate 220.

As a first example, the first electrode 230 may be formed on a top surface of the first transparent substrate 210 and the second electrode 250 may be formed on a top surface of the second transparent substrate 220.

Further, as a second example, the first electrode 230 may be formed on a bottom surface of the first transparent substrate 210 and the second electrode 250 is formed on a top surface of the second transparent substrate 220, such that the first electrode 230 and the second electrode 250 may be formed to face each other based on an adhesive layer 270. In this case, the first transparent substrate 210 may be a window that is provided at an outermost side of the touch panel 200. When the first transparent substrate 210 is a window, the first electrode 230 is directly formed on the window to remove a process of forming the first electrode 230 on a separate transparent substrate and attaching the first electrode 230 to the window, thereby simplifying the manufacturing process and reducing the overall thickness of the touch panel 200. However, the touch panel 200 according to the second preferred embodiment of the present invention is not necessarily limited to the case in which the first transparent substrate 210 is formed of a window.

Meanwhile, the first electrode 230 and the second electrode 250 are each formed on the surfaces of the first transparent substrate 210 and the second transparent substrate 220, but are each formed to cross the first groove portion 221 and the second groove portion 222 that are each formed on the surfaces of the first transparent substrate 210 and the second transparent substrate 220. In this case, the first electrode 230 and the second electrode 250 are formed along bottom surfaces and sides of the first groove portion 221 and the second groove portion 222, but may be formed in an orthogonal direction to the first groove portion 221 and the second groove portion 222.

Here, for example, the first electrode 230 may be formed on one surface of the first transparent substrate 110 in a plurality of columns and the second groove portion 222 may be formed in a plurality of rows. In this case, the first electrode 230 and the first groove portion 221 are formed in an orthogonal direction to each other and the second electrode 250 and the second groove portion 222 may be formed in an orthogonal direction to each other.

However, the second preferred embodiment of the present invention is not limited to the case in which the first electrode 230 is formed on the first transparent substrate 210 in a column and the second electrode 250 is formed on the second transparent substrate 220 in a row. For example, the first electrode 230 may be formed on the first transparent substrate 210 in a row and the second electrode 250 may be formed on the second transparent substrate 210 in a column.

Further, the first electrode 230 and the second electrode 250 may be formed at a thickness 30% smaller than the depths and the widths of the first groove portion 221 and the second groove portion 222. In this case, the first electrode 230 and the second electrode 250 may be formed in, for example, a thin film form.

Further, the transverse sections of the first groove portion 221 and the second groove portion 222 may be in a rectangular shape, but the present invention is not limited thereto.

In detail, the first and second electrodes 230 and 250 may be formed of copper (Cu), aluminum (Al), gold (Au), silver (Ag), titanium (Ti), palladium (Pd), and chromium (Cr), or a combination thereof. Herein, the first and second electrodes 230 and 250 may be formed in, for example, a mesh pattern (see FIG. 4). In this case, the first and second electrodes 230 and 250 may be formed by a plating process or a deposition process.

Meanwhile, when the first and second electrodes 230 and 250 are formed of copper (Cu), the surfaces of the first and second electrode electrodes 230 and 250 may be preferably black-oxidized. Here, the black-oxidation elutes Cu₂O or CuO by oxidizing the surfaces of the first and second electrodes 230 and 250. Meanwhile, the Cu₂O has brown, and therefore is referred to as brown oxide and the CuO has black, and therefore is referred to as black oxide. As such, the reflection of light may be prevented by black-oxidizing the surfaces of the first and second electrodes 230 and 250, such that the visibility of the touch panel 200 may be improved.

Further, the first and second electrodes 230 and 250 may be formed to have a line width of 7 μm or less and a pitch of 900 μm or less, such that the visibility of the touch panel 200 may be improved. However, the line width and the pitch of the first and second electrodes 230 and 250 according to the first preferred embodiment of the present invention are not limited thereto.

Meanwhile, in addition to the foregoing metals, the first and second electrodes 230 and 250 may also be formed of metal silver formed by exposing/developing a silver salt emulsion layer.

Further, the first and second electrodes 230 and 250 may be formed to have a surface shape by using conductive polymer or metal oxide as another example.

Here, the conductive polymer has excellent flexibility and a simple coating process. In this case, the conductive polymer may be formed of poly-3,4-ethylenedioxythiophene/polystyrenesulfonate (PEDOT/PSS), polyaniline, polyacetylene, or polyphenylenevinylene.

In addition, the metal oxide may be formed of indium-tin oxide.

Further, when the first and second electrodes 230 and 250 are formed of conductive polymer or metal oxide, the first and second electrodes 230 and 250 may be formed by a dry process, a wet process, or a direct patterning process. Here, the dry process means sputtering, evaporation, and the like, the wet process means dip coating, spin coating, roll coating, spray coating, and the like, and the direct patterning process means screen printing, gravure printing, inkjet printing, and the like.

Here, when the first and second electrodes 230 and 250 are formed of conductive polymer or metal oxide, the first and second electrodes 230 and 250 may be formed in a bar type pattern in the drawings, but the present invention is not limited thereto. Therefore, the first and second electrodes 130 and 150 may be formed in all the patterns known in the art such a diamond pattern, a quadrangular pattern, a triangular pattern, a circular pattern, and the like.

The adhesive layer 270 adheres between the first transparent substrate 210 and the second transparent substrate 220. Here, the adhesive layer 270 is not particularly limited, but an optical clear adhesive (OCA) may be used.

Meanwhile, the touch panel 200 according to the second preferred embodiment of the present invention may be further provided with an insulating layer (not illustrated). Here, the insulating layer is formed on one surface of the second transparent substrate 220 so as to cover the second electrode 250 formed on the second transparent substrate 220. In this case, the adhesive layer 270 is disposed between the insulating layer and the first transparent substrate 210, such that the first transparent substrate 210 may be adhered to the second transparent substrate 220 by the bonding between the insulating layer and the first transparent substrate 210.

Meanwhile, the image display device that serves to output images in the other surface direction of the second transparent substrate 220 may be provided. Here, the image display device may be bonded to the other surface of the second transparent substrate 220 by the optical clear adhesive (OCA).

In addition, an edge of the first electrode 230 is provided with a first electrode wiring 240 that is supplied with an electrical signal from the first electrode 230 and an edge of the second electrode 250 is formed with the second electrode wiring 260 that is supplied with an electrical signal from the edge of the second electrode 250. In this case, the first electrode wiring 240 is integrally formed with the first electrode 230 and the second electrode wiring 260 is integrally formed with the second electrode 250, thereby simplify the manufacturing process and shorten lead time.

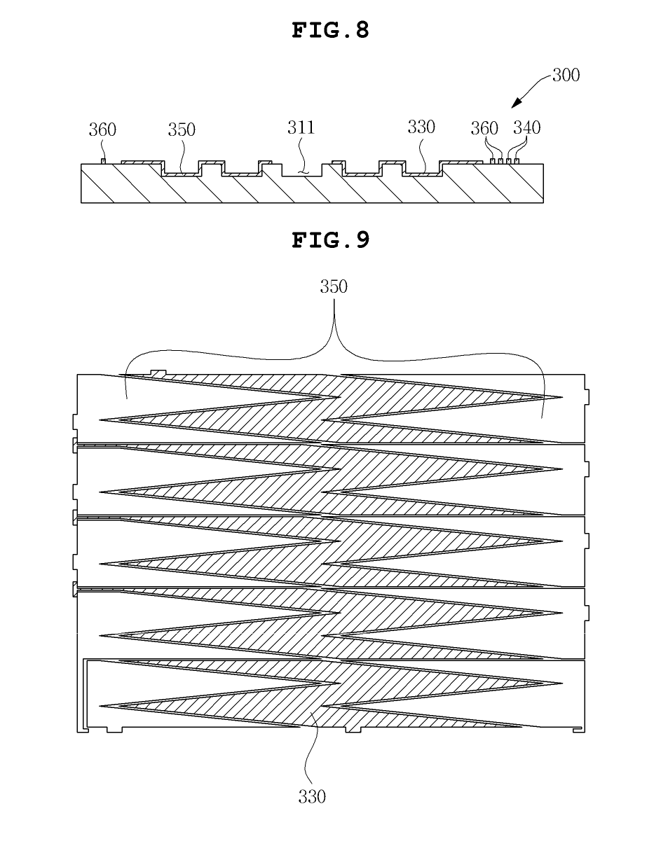

FIG. 7 is an exploded perspective view of a touch panel according to a third preferred embodiment of the present invention and FIG. 8 is a cross-sectional view of the touch panel according to the third preferred embodiment of the present invention.

As illustrated in FIGS. 7 and 8, a touch panel 300 according to the preferred embodiment of the present invention is configured to include a transparent substrate 310 having one surface on which a groove portion 311 is formed and a first electrode 330 and a second electrode 350 formed on one surface of the transparent substrate 310.

Comparing with the touch panels 100 and 200 according to the first and second preferred embodiments, the touch panel 300 according to the third preferred embodiment of the present invention has a difference in that the first electrode 330 and the second electrode 350 are formed on one surface of the transparent substrate 310. Therefore, the contents in which the third preferred embodiment of the present invention overlaps the first and second preferred embodiments of the present invention will be briefly described and only the difference therebetween will be mainly described.

First, one surface of the transparent substrate 310 is provided with a groove portion 311. Here, the groove portion 311 may be formed on one surface of the transparent substrate 310 in a plurality of rows or columns.

Further, the transparent substrate 310 serves to provide an area in which the first and second electrodes 330 and 350 are formed. In this case, the high frequency treatment or the primer treatment may be performed so as to activate one surface of the transparent substrate 310. As such, the adhesion between the transparent substrate 310 and the first and second electrodes 330 and 350 can be improved by activating one surface of the transparent substrate 310.

Meanwhile, the transparent substrate 310 may be a window that is provided at an outermost side of the touch panel 300. When the transparent substrate 310 is a window, the first electrode 330 is directly formed on the window to remove a process of forming the first electrode 330 on the separate transparent substrate 310 and attaching the first electrode 330 to the window, thereby simplifying the manufacturing process and reducing the overall thickness of the touch panel 300. However, the transparent substrate 310 of the touch panel 300 according to the third preferred embodiment of the present invention is not necessarily limited thereto.

The first and second electrodes 330 and 350 generate signals when being touched by a user so as to allow a controller to recognize touched coordinates. Here, the first and second electrodes 330 and 350 are each formed on one surface of the transparent substrate 310.

Further, the first and second electrodes 330 and 350 are each formed to cross the groove portion 311 formed on one surface of the transparent substrate 310. In this case, the first electrode 330 and the second electrode 350 are formed along a bottom surface and a side of the groove portion 311 but may be formed in an orthogonal direction to the groove portion 311.

Here, the first and second electrodes 330 and 350 are each formed, for example, on one surface of the transparent substrate 310 in a plurality of columns or rows. In this case, the first electrode 330 and the second electrode 350 may be alternately formed on the transparent substrate 310.

Meanwhile, the first electrode 330 and the second electrode 350 may be formed at a thickness 30% smaller than a depth and a width of the groove portion 311. In this case, the first electrode 330 and the second electrode 350 may be formed in, for example, a thin film form.

Further, the transverse section of the groove 311 may be formed in a rectangular shape, but the present invention is not limited thereto.

In detail, the first and second electrodes 330 and 350 may be formed of copper (Cu), aluminum (Al), gold (Au), silver (Ag), titanium (Ti), palladium (Pd), and chromium (Cr), or a combination thereof. Here, the first and second electrodes 330 and 350 may be formed in, for example, a mesh pattern (see FIG. 4). In this case, the first and second electrodes 330 and 350 may be formed by a plating process or a deposition process. Meanwhile, when the first and second electrodes 330 and 350 are formed of copper (Cu), the surfaces of the first and second electrode 330 and 350 may be preferably black-oxidized. Here, the black-oxidation elutes Cu₂O or CuO by oxidizing the surfaces of the first and second electrodes 330 and 350. Meanwhile, the Cu₂O has brown, and therefore is referred to as brown oxide and the CuO has black, and therefore is referred to as black oxide. As such, the reflection of light may be prevented by black-oxidizing the surfaces of the first and second electrodes 330 and 350, such that the visibility of the touch panel 300 may be improved.

Further, the first and second electrodes 330 and 350 may be formed to have a line width of 7 μm or less and a pitch of 900 μm or less, such that the visibility of the touch panel 300 may be improved. However, the line width and the pitch of the first and second electrodes 330 and 350 according to the first preferred embodiment of the present invention are not limited thereto.

Meanwhile, in addition to the foregoing metals, the first and second electrodes 330 and 350 may also be formed of metal silver formed by exposing/developing a silver salt emulsion layer.

Further, the first and second electrodes 330 and 350 may be formed to have a surface shape by using conductive polymer or metal oxide.

Here, the conductive polymer has excellent flexibility and a simple coating process. In this case, the conductive polymer may be formed of poly-3,4-ethylenedioxythiophene/polystyrenesulfonate (PEDOT/PSS), polyaniline, polyacetylene, or polyphenylenevinylene.

In addition, the metal oxide may be formed of indium-tin oxide.

Further, when the first and second electrodes 330 and 350 are formed of conductive polymer or metal oxide, the first and second electrodes 330 and 350 may be formed by a dry process, a wet process, or a direct patterning process. Here, the dry process means sputtering, evaporation, and the like, the wet process means dip coating, spin coating, roll coating, spray coating, and the like, and the direct patterning process means screen printing, gravure printing, inkjet printing, and the like.

Here, when the first and second electrodes 330 and 350 are formed of conductive polymer or metal oxide, the first and second electrodes 330 and 350 may be formed in a bar type pattern in the drawings, but the present invention is not limited thereto. Therefore, the first and second electrodes 330 and 350 may be formed in all the patterns known in the art such a diamond pattern, a quadrangular pattern, a triangular pattern, a circular pattern, and the like.

FIG. 9 is a plan view illustrating another example of an electrode pattern in the touch panel according to the third preferred embodiment of the present invention.

The first electrode 330 and the second electrode 350 are formed in, for example, a triangular pattern, but the first electrode 330 and the second electrode 350 may be formed to face each other in a form corresponding to each other (see FIG. 7).

Further, the first electrode 330 and the second electrode 350 are formed in, for example, a triangular pyramid pattern, but the first electrode 330 and the second electrode 350 may be formed to face each other in a form corresponding to each other. Here, the plurality of first electrodes 330 are protruded to both sides in a triangular pyramid shape and the second electrode 350 is provided in plural so as to be each disposed on both sides of the first electrode 330 while facing each other.

Meanwhile, the image display device that serves to output images in the other surface direction of the transparent substrate 310 may be provided. Here, the image display device may be bonded to the other surface of the transparent substrate 310 by the optical clear adhesive (OCA).

In addition, an edge of the first electrode 330 is provided with a first electrode wiring 340 that is supplied with an electrical signal from the first electrode 330 and an edge of the second electrode 350 is formed with the second electrode wiring 360 that is supplied with an electrical signal from the edge of the second electrode 350. In this case, the first electrode wiring 340 is integrally formed with the first electrode pattern 330 and the second electrode wiring 360 is integrally formed with the second electrode 350, thereby simplify the manufacturing process and shorten lead time.

According to the preferred embodiments of the present invention, the electrode pattern can be discontinuously formed by forming the groove on the transparent substrate to prevent the electrode pattern from being visualized, thereby remarkably improving the visibility.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate having one surface on which a first groove portion is formed and the other surface on which a second groove is formed;
a first electrode formed on one surface of the transparent substrate so as to cross the first groove portion; and
a second electrode formed on the other surface of the transparent substrate so as to cross the second groove portion.

2. The touch panel as set forth in claim 1, wherein the first groove portion is formed in a plurality of rows and the second groove portion is formed in a plurality of columns.

3. The touch panel as set forth in claim 1, wherein the first electrode is formed in a plurality of columns and the second electrode is formed in a plurality of rows.

4. The touch panel as set forth in claim 1, wherein the first electrode and the second electrode are each formed along both surfaces of the transparent substrate and formed along bottom surfaces and sides of the first groove portion and the second groove portion.

5. The touch panel as set forth in claim 4, wherein the first electrode and the second electrode are formed at a thickness 30% smaller than depths and widths of the first groove portion and the second groove portion.

6. The touch panel as set forth in claim 1, wherein transverse sections of the first groove portion and the second groove portion are formed in a quadrangular shape.

7. A touch panel, comprising:
a first transparent substrate having one surface on which a first groove portion is formed;
a first electrode formed on one surface of the first transparent substrate so as to cross a first groove portion;
a second transparent substrate having one surface on which a second groove portion is formed;
a second electrode formed on one surface of the second transparent substrate so as to cross the groove; and
an adhesive layer formed between the first transparent substrate and the second transparent substrate.

8. The touch panel as set forth in claim 7, wherein the first groove portion is formed in a plurality of rows and the second groove portion is formed in a plurality of columns.

9. The touch panel as set forth in claim 7, wherein the first electrode is formed in a plurality of columns and the second electrode is formed in a plurality of rows.

10. The touch panel as set forth in claim 7, wherein the first electrode and the second electrode are each formed along both surfaces of the first transparent substrate and the second transparent substrate and formed along bottom surfaces and sides of the first groove portion and the second groove portion.

11. The touch panel as set forth in claim 10, wherein the first electrode and the second electrode are formed at a thickness 30% smaller than depths and widths of the first groove portion and the second groove portion.

12. The touch panel as set forth in claim 7, wherein transverse sections of the first groove portion and the second groove portion are a quadrangular shape.

13. A touch panel, comprising:
a transparent substrate having one surface on which a groove portion is formed; and
a first electrode and a second electrode formed on one surface of the transparent substrate to cross the groove portion.

14. The touch panel as set forth in claim 13, wherein the groove portion is formed in a plurality of rows or columns.

15. The touch panel as set forth in claim 13, wherein the first electrode and the second electrode are formed in a plurality of rows or columns.

16. The touch panel as set forth in claim 13, wherein the first and second electrodes are alternately formed.

17. The touch panel as set forth in claim 13, wherein the first electrode and the second electrode are formed on one surface of the transparent substrate and formed along a bottom surface and a side of the groove portion.

18. The touch panel as set forth in claim 13, wherein the transverse section of the groove portion is formed in a quadrangular shape.

19. The touch panel as set forth in claim 13, wherein the first electrode and the second electrode are formed in a thickness 30% smaller than a depth and a width of the groove portion.
